(19) United States
(12) Patent Application Publication
(10) Pub. No.: US 2022/0061531 A1
(43) Pub. Date: Mar. 3, 2022

(54) LOCKING SYSTEM AND METHOD FOR SHELVES

(71) Applicant: BORTOLUZZI SISTEMI S.P.A., Belluno (IT)

(72) Inventors: Bruno SPONGA, Belluno (IT); Marco PIANCA, Belluno (IT)

(21) Appl. No.: 17/415,064

(22) PCT Filed: Dec. 15, 2019
(86) PCT No.: PCT/IB2019/060813

§ 371 Date: Jun. 17, 2021

(30) Foreign Application Priority Data
Dec. 18, 2018 (IT) 102018000020011

(51) Int. Cl. A47B 96/02; A47B 96/06

(52) U.S. Cl. CPC A47B 96/021; F16B 12/26; A47B 96/066

(57) ABSTRACT

To lock a shelf (12) of a furniture item or of a shelving unit to a fixed element (50) projecting from the wall of the furniture item or shelving unit, on the sides (18) of the shelf a superficial groove (20) is made which is formed by the junction of at least a first segment (22) which is—in use—vertical and

a second segment (24) which is angled with respect to the first one and has a blind end,

so that the groove can be coupled to the fixed element thereby bringing the latter to the blind end by travelling the first and second segments in sequence.

The invention relates to a locking system and method for shelves of furniture or shelving units.

It is known that furniture items or cabinets are furnished with shelves that often are not sliding and extractable horizontally, that is, the shelf is fixed to the furniture walls. For reasons of economy and ease of assembly, the fixing occurs between a plug protruding from the wall and a corresponding vertical recess in the shelf.

Clearly the biggest disadvantage is that the shelf could be raised accidentally, since only its weight binds it to the furniture item.

Improving this state of the art is the main object of the invention, which is defined in the appended claims, in which the dependent ones define advantageous variants.

Another object is to provide a shelf of the above mentioned type which is simple to produce and easy to assemble.

Another object is to make a shelf of the above mentioned type which is inexpensive to produce.

Another object is to provide an improved assembly given by a shelf of the above mentioned type and means for fixing it to the furniture item.

A shelf, of furniture item or shelving unit, is proposed lockable to a fixed element protruding from the wall of the furniture item or shelving unit, wherein

the shelf comprises a support surface for supporting objects and the opposite sides of the shelf each comprise a surface groove which has

an entrance/inlet at the base of the side and

a blind end connected by a channel that deviates (e.g. substantially by 90 degrees) with respect to a line orthogonal to the support surface,

the groove being configured so that the fixed element can be inserted into the entrance and placed at the blind end by sliding along the channel.

In this way, the fixed element can be fitted at the end of the groove without letting it going out. The geometry of the surface groove, which is not straight but with at least one change of direction, ensures that the fixed element cannot come out of the surface groove if the shelf is raised vertically.

Another aspect of the invention relates to a system for locking a shelf of a furniture item or shelving unit to a fixed element protruding from the wall of the furniture item or shelving unit, comprising

a shelf as in any of the variants,

a fixed element protruding from the wall of the furniture item or shelving unit,

the groove and the fixed element being configured so that the groove can be coupled to the fixed element thereby carrying the latter to the blind end by following the first and second segment in sequence.

Another aspect of the invention relates to a method for locking a shelf of a furniture item or shelving unit to a fixed element protruding from the wall of the furniture item or shelving unit, comprising the steps of

making a surface groove on the sides of the shelf which is formed

from the connection of

at least a first segment which is—in use—vertical and

a second segment that is angled with respect to the first and has a blind end,

so that the groove can be coupled to the fixed element thereby carrying the latter to the blind end by running the first and second segment in sequence.

Here are some preferred variants for these aspects of the invention.

According to a preferred embodiment, which simplifies the assembly, the channel comprises

a first segment connected to a second segment,

the first segment being substantially orthogonal to an imaginary plane in which the support surface lies and having at one end said entrance, and

the second segment being angled with respect to the first one and ending with said blind end.

According to a more preferred embodiment, the first and second segments are arranged substantially at 90 degrees to each other.

To facilitate assembly, preferably the second segment is substantially parallel to said imaginary plane.

To improve the stability of the shelf, preferably the shelf comprises an undercut that extends under the perimeter of the channel at least at the blind end; thus the fixed element can be retained by the undercut.

Preferably the shelf comprises an undercut which extends under the perimeter of the second segment and preferably also of the first one.

To facilitate the insertion of the fixed element into the groove, the edges of the first segment are converging towards a connection area with the second segment.

Preferably, the fixed element comprises a stem for fixing to the furniture item and a protruding mushroom-shaped head, wherein the perimeter of the channel, at least for the portion at the blind end and/or for the portion deflected by said orthogonal line, is narrower than said head.

Preferably the dimensions of the stem are such as to allow it to enter the width of the first and second segment, the dimensions of the head being greater than the width of the first and second segment and such as to allow it to only enter the undercut.

Preferably the system comprises an element which can be jointed in the first segment to block the fixed element inside the second segment.

Even more preferably the jointable element comprises an elastically deformable portion adapted to press against the shelf when the jointable element is inserted in the first segment.

Preferably the jointable element comprises an elastically deformable portion adapted to press the edges of the first segment when the jointable element is inserted in the first segment.

Preferably in the method there is the step of trapping the fixed element inside the second segment occluding the first segment, e.g. by inserting an obstacle into the second segment. Such obstacle may be e.g. configured as the aforementioned jointable element.

The advantages of the invention will be even clearer from the following description of a preferred exemplary system, referring to the attached drawing in which

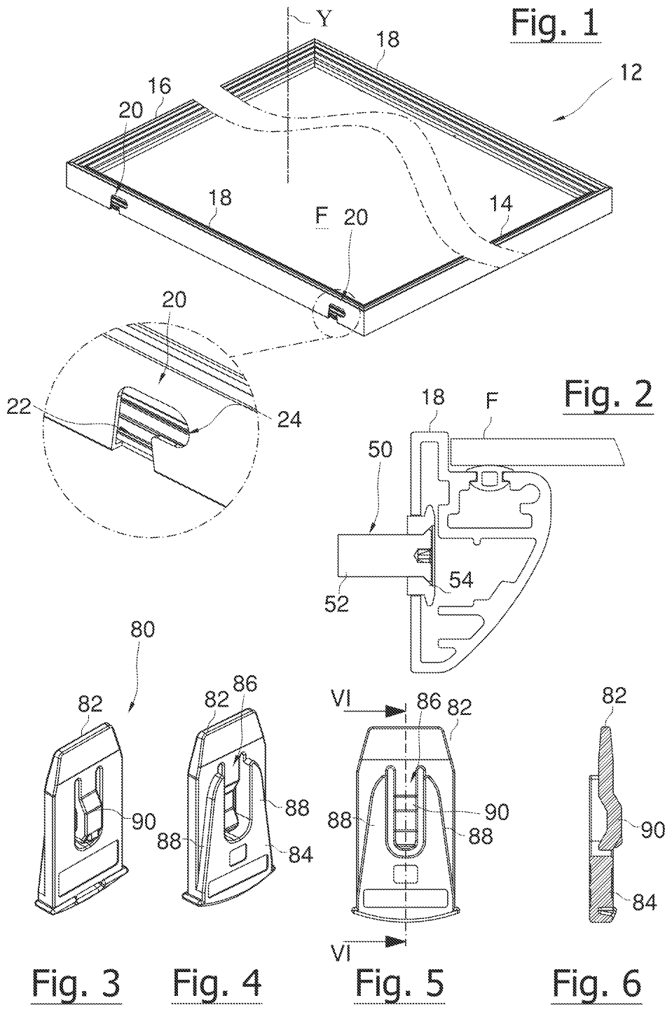

FIG. 1 shows a three-dimensional view of a shelf for a furniture item or shelving unit;

FIG. 2 shows a vertical cross-sectional view of the shelf according to the VI-VI plane of FIG. 1;

FIGS. 3-4 show three-dimensional views of a blocking component;

FIG. 5 shows a front view of the component of FIG. 4;

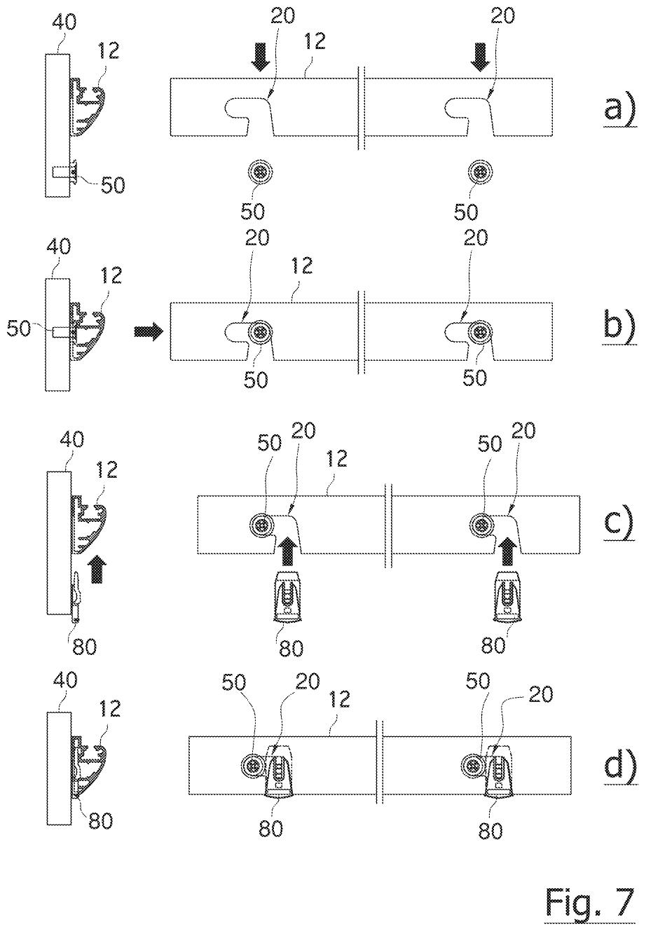

FIG. 6 shows a vertical cross-sectional view of the component of FIG. 4 according to plane VI-VI of FIG. 5;

FIG. 7 shows an assembly sequence for the shelf in FIG. 1.

In the figures equal numbers indicate equal or conceptually similar parts, and the elements are described as in use. In order not to crowd the figures some numeric references are omitted.

FIG. 1 shows a shelf 12 comprising a frame formed by a front segment 14, a bottom segment 16 and two lateral segments 18. The segments 14, 16, 18 are e.g. tubular parts with ends cut at 90 degrees to fit together, and are assembled to form an overall rectangular or square frame. The bottom of the shelf 12 is indicated by F, and it lies on a—in use—horizontal plane, namely orthogonal to a Y axis.

The lateral segments 18 are each provided with at least two identical sides openings or slots 20, which can be carved out of the material or obtained by material removal.

Each slot 20 is formed by the union of a vertical segment 22, parallel to the Y axis, and a horizontal segment 24, oriented at about 90 degrees with respect to the first one along the direction of the length of the segment 18.

The vertical segment 22 extends from the lower edge of the segment 18 to approximately its half height, and has a tapering width. The horizontal segment 24 has substantially a constant width.

Both the edges of the vertical segment 22 and those of the horizontal segment 24 are provided with an undercut.

The fixing of the shelf to a wall 40 occurs by means of four supports 50, two for each segment 18. The supports 50 have a stem 52 fixed to the wall 40 and a mushroom-shaped protruding head 54, see FIGS. 2 and 7a.

The stem 52 has such dimensions that it can be inserted and can slide into the vertical segment 22 (FIG. 7b) and then along the horizontal segment 54, up to a limit position (FIG. 7c).

The distance between the edges of the vertical segment 52 is greater than the width of the head 54.

The distance between the edges of the horizontal segment 24 is substantially equal to the width of the stem 52, therefore less than the width of the head 54, which head can remain trapped inside the undercut.

To mount the shelf 12 (FIG. 7a), it is moved closer to the supports 50.

By aligning the supports 50 with the vertical segments 22, the supports 50 are inserted inside the vertical segments 22 (FIG. 7b) by lowering the shelf 12.

Then, by moving the shelf 12 horizontally, the supports 50 are inserted inside the respective horizontal segment 24 (FIG. 7c), with a movement that brings the supports 50 at the end of the respective horizontal segment 24 (FIG. 7c).

Even in the configuration of FIG. 7c the shelf 12 cannot be released from the supports 50 with an ordinary displacement. In particular, the supports 50 oppose a vertical lifting thereof.

In a preferred variant, the shelf 12 is blocked in a static position on the supports 50 by means of at least one blocking element, in particular an element inserted or insertable into the slot 20 to close a horizontal segment 24 thereby preventing a backward displacement of the support 50 placed therein.

A preferred blocking element 80 is shown in FIGS. 3÷6 and FIG. 7d.

It is a block, e.g. made of plastic or rubber or deformable material, formed by the union of a parallelepiped element, with an approximately rectangular base 82, superimposed on a truncated cone-shaped relief 84, which have a short base on the same plane. The rectangular base of element 82 is as wide as the entrance of the segment 22, while the perimeter of the frustoconical relief 84 is complementary to the edges of the segment 22. It follows that the element 80 can be inserted snugly into the segment 22. After insertion, the edges of the parallelepiped element 82 have slipped into the undercut of the segment 22 while the perimeter of the relief 84 abuts against the edges of the segment 22 (FIG. 7d).

Advantageously, the blocking element 80 remains stable inside the segment 22 thanks to the pressure of the undercut on the element 82.

Advantageously, the blocking element 80 fills the cavity of the segment 22 thanks to the relief 84, thereby avoiding discontinuity in the volume of the segment 18.

To prevent the blocking element 80 from slipping out of the segment 22, it is preferable to modify the blocking element 80.

E.g. the relief 84 comprises a central recess 86 which divides the tapered part thereof into two parts 88. The parts 88 can come closer to each other by slightly flexing during insertion into the segment 22, and by returning elastically into position they press against the edges of the segment 22, thereby improving the anchoring on the segment 18.

Alternatively or in combination, the blocking element 80 may comprise a flexible flap 90 which at rest protrudes from the plane of the rectangular base of the parallelepiped element 82 and which can flex to go back inside such base more (jutting out less). When the blocking element 80 is inserted into the segment 22, the flap 90 presses elastically against a wall of the segment 22, and by friction it increases the anchoring force to the segment 18.

1. Shelf of furniture item or shelving unit lockable to a fixed element projecting from the wall of the furniture item or shelving unit, wherein
the shelf comprises a supporting surface for supporting objects and the opposite sides of the shelf each comprise a surface groove
having an entrance/inlet at the base of the side and a blind end connected by a channel which deviates with respect to a line orthogonal to the supporting surface,
the groove being configured so that the fixed element can be inserted into the inlet and placed at the blind end by sliding along the channel.

2. Shelf according to claim 1, wherein the channel comprises a first segment connected to a second segment, the first segment being substantially orthogonal to an imaginary plane on which the supporting surface lies and having at one end said inlet, and the second segment being angled with respect to the first one and ending with said blind end.

3. Shelf according to claim 1, wherein the first and second segments are arranged substantially at 90 degrees with respect to each other.

4. Shelf according to claim 1, comprising an undercut extending under the perimeter of the channel at least at the blind end.

5. Shelf according to claim 1, wherein the edges of the first segment are converging towards a connecting zone with the second segment.

6. System for locking a shelf of a piece of furniture or a shelving unit to a fixed element projecting from the wall of the piece of furniture or shelving unit, comprising
a shelf as in any one of the previous claims,
a fixed element projecting from the wall of the piece of furniture or shelving unit,
the groove and the fixed element being configured so that the groove is couplable to the fixed element thereby bringing the latter to the blind end by travelling the first and second segments in sequence.

7. System according to claim 6, wherein the fixed element comprises a stem for fixing to the furniture item and a mushroom-shaped protruding head,
wherein the perimeter of the channel, at least for the portion at the blind end and/or for the portion deviated from said orthogonal line, is narrower than said head.

8. System according to claim 7, wherein
the dimensions of the stem are such as to allow it to enter the width of the first and second segments,
the dimensions of the head being greater than the width of the first and second segments and such as to allow it to enter only the undercut.

9. System according to claim comprising an element insertable in the first segment to block the fixed element inside the second segment.

10. Method for locking a shelf of a furniture item or of a shelving unit to a fixed element projecting from the wall of the of furniture item or shelving unit, comprising the steps of
making on the sides the shelf a superficial groove which is formed by the junction of
at least a first segment which is—in use—vertical and
a second segment which is angled with respect to the first one and has a blind end,
so that the groove can be coupled to the fixed element by bringing the latter to the blind end by travelling the first and second segments in sequence.
